(19) United States
(12) Patent Application Publication
(10) Pub. No.: US 2009/0030964 A1
(43) Pub. Date: Jan. 29, 2009

(54) MATRIX OPERATION DEVICE

(76) Inventor: Toshiki Tada, Osaka (JP)

Correspondence Address: WENDEROTH, LIND & PONACK L.L.P., 2033 K. STREET, NW, SUITE 800, WASHINGTON, DC, 20006, US

(21) Appl. No.: 11/915,529

(22) PCT Filed: May 1, 2006
(86) PCT No.: PCT/JP2006/309111

§ 371 Date: Nov. 26, 2007

(30) Foreign Application Priority Data
May 25, 2005 (JP) 2005-153139

(51) Int. Cl. G06F 7/52; G06F 17/16

(52) U.S. Cl. 708/607

(57) ABSTRACT

There is provided a matrix operation device comprising a k201-th power weighting multiplication circuit (202) for weighting inputs with k201-th power weighting coefficients (202b) which are obtained by multiplying weighting coefficients (202a) by 2 to the k201-th power and then integerizing the product, a k202 bit shift multiplication circuit (206) for performing bit-shift multiplication by k202 bit shift on the multiplication result of the k201-th power weighting multiplication circuit (202), a correction circuit (207) for adding a correction value to the multiplication result of the k202 bit shift multiplication circuit (206), a round-off circuit (204) for rounding off the operation result of the correction circuit (207), and an n bit shift division circuit (205) for performing bit shift division by n bit shift (n=k201+k202) on the operation result of the round-off circuit (204). Thereby, the amount of operation is reduced to reduce the circuit scale, and operation accuracy is improved.

### TECHNICAL FIELD

The present invention relates to a matrix operation device, and more particularly, to an operation device used for image conversion such as video signal processing or the like.

### BACKGROUND ART

In recent years, there have been used a lot of image frequency sampling techniques using such as discrete cosine transform (DCT)/inverse discrete cosine transform (IDCT). Realization of such image sampling leads to reduction in primary storage units (memories) required for image conversion or the like.

FIG. 1 is a block diagram illustrating a conventional matrix operation device, and FIG. 2 is a diagram illustrating a specific construction of the conventional matrix operation device.

With reference to FIGS. 1 and 2, 101 denotes external inputs, 102 denotes a weighting multiplication circuit, 103 denotes an addition circuit, 104 denotes a round-off circuit, and 105 denotes an n bit shift division circuit.

In the construction of the conventional matrix operation device, with respect to weighting coefficients 102a for the plural inputs 101, all of these coefficients are multiplied by a specific multiplier (2ⁿ) to expand the coefficients up to values which ensure sufficient operation accuracy, and thereafter, these coefficients are integerized to realize weighting coefficients 102b. Then, the respective inputs 101 are subjected to weighting multiplication by the weighting multiplication circuit 102 using the weighting coefficients 102b, and the products obtained by the weighting multiplication circuit 102 are added by the addition circuit 103. After the output of the addition circuit 103 is rounded off by the round-off circuit 104, the resultant is subjected to bit shift division by the expanded amount with which the weighting coefficients 102a have been multiplied for ensuring operation accuracy, by the bit shift division circuit 105, thereby realizing weighting operation to be performed with the original weighting coefficients 102a. In order to perform this operation, for example, Patent Document 1 proposes simplification of a matrix operation circuit, and Patent Document 2 proposes reduction in an accumulation circuit, thereby realizing reduction in circuit scale by simplifying the circuit construction of the operation device.

Patent Document 1: Japanese Published Patent Application No. Hei. 5-158966

Patent Document 2: Japanese Published Patent Application No. Hei. 10-916105

### DISCLOSURE OF THE INVENTION

### Problems to be Solved by the Invention

In the conventional construction, in order to secure sufficient operation accuracy in matrix operation represented by DCT/IDCT, the original conversion matrix coefficients are multiplied by 2 to the n-th power to be expanded to sufficiently large coefficients for matrix operation. In the conventional construction, however, since the conversion matrix coefficients are realized by multiplying the original coefficients by a very large value in the matrix operation which requires very high accuracy, the operation results obtained by the conversion matrix coefficients become very large, whereby a multiplication circuit and the like are increased when the matrix operation is realized as a circuit, leading to increase in the total circuit scale. Especially when there is a large difference between coefficients for a matrix operation in a system for down-sampling and up-sampling which are performed for thinning out high-frequency components, a specific multiplied value becomes very large, leading to increase in the total circuit scale. Further, since the multiplication circuit is increased, a primary storage circuit (FF) or the like is required to satisfy timing limitation or the like for circuit realization, leading to further increase in the circuit scale.

The present invention is made to solve the above-described problems and has for its object to provide a matrix operation device that can realize a highly accurate operation result relative to the conventional device, while reducing the circuit scale of a multiplication circuit.

Further, it is another object of the present invention to provide a matrix operation device that can dispense with a primary storage circuit (FF) for timing limitation.

### Measures to Solve the Problems

In order to solve the above-mentioned problems, according to a matrix operation device of the present invention, matrix operation is carried out without expanding matrix operation coefficients up to very large coefficient values, whereby the amount of operation is reduced and the circuit scales of multiplication circuits and the like are reduced. Further, the precision of operation is improved by adding a correction coefficient to the multiplication result.

According to claim 1 of the present invention, there is provided a matrix operation device for performing weighting operation on i pieces of inputs (i: an integer not less than 1) by using m or more pieces of weighting coefficients (m: integer not less than 1), comprising: a k1-th power weighting multiplication circuit for weighting the inputs with k1-th power weighting coefficients which are obtained by multiplying the weighting coefficients by 2 to the k1-th power and then integerizing the product; a k2 bit shift multiplication circuit for performing bit shift multiplication by k2 bit shift on the multiplication result of the k1-th power weighting multiplication circuit; a correction circuit for adding a correction value that is calculated using correction coefficients, to the multiplication result of the k2 bit shift multiplication circuit; a round-off circuit for rounding off the operation result of the correction circuit; and a k bit shift division circuit for performing bit shift division by k bit shift (k=k1+k2) on the operation result of the round-off circuit.

According to Claim 2 of the present invention, in the matrix operation device defined in Claim 1, the correction coefficients are coefficients for correcting differences between the results which are obtained by weighting the inputs with the k1-th power weighting coefficients and then subjecting the products to k2 bit shift multiplication, and the results which are obtained by weighting the inputs with the coefficients that are obtained by multiplying the weighting coefficients by two to the k-th power.

According to Claim 3 of the present invention, in the matrix operation device defined in Claim 1, optimum correction coefficients are used on the basis of an allowable range of precision of the operation result of the correction circuit.

According to Claim 4 of the present invention, there is provided a matrix operation device for performing weighting operation on i pieces of inputs (i: integer not less than 1) with m or more pieces of weighting coefficients (m: integer not less than 1), comprising: a k1-th power weighting multiplication circuit for weighting the inputs with k1-th power weighting coefficients which are obtained by multiplying the weighting coefficients by 2 to the k1-th power and then integerizing the product; a first correction circuit for adding a first correction value that is calculated using first correction coefficients, to the product obtained by the k1-th power weighting multiplication circuit; a k2 bit shift multiplication circuit for performing bit shift multiplication by k2 bit shift on the operation result of the first correction circuit; a second correction circuit for adding a second correction value that is calculated using second correction coefficients, to the product obtained by the k2-th power weighting multiplication circuit; a round-off circuit for rounding off the operation result of the second correction circuit; and a k bit shift division circuit for performing bit shift division by k bit shift (k=k1+k2) on the operation result of the round-off circuit.

According to Claim 5 of the present invention, there is provided a matrix operation device for performing weighting operation on i pieces of inputs (i: integer not less than 1) with m or more pieces of weighting coefficients (m: integer not less than 1), comprising: a k1-th power weighting multiplication circuit for weighting the inputs with k1-th power weighting coefficients which are obtained by multiplying the weighting coefficients by 2 to the k1-th power and then integerizing the product; a k2 bit shift multiplication circuit for performing bit shift multiplication by k2 bit shift on the product obtained by the k1-th power weighting multiplication circuit; a first correction circuit for adding a first correction value that is calculated using first correction coefficients, to the product obtained by the k2 bit shift multiplication circuit; a k3 bit shift multiplication circuit for performing bit shift multiplication by k3 bit shift on the operation result of the first correction circuit; a second correction circuit for adding a second correction value that is calculated using second correction coefficients, to the product obtained by the k3 bit shift multiplication circuit; a round-off circuit for rounding off the operation result of the second correction circuit; and a k bit shift division circuit for performing bit shift division by k bit shift (k=k1+k2+k3) on the operation result of the round-off circuit.

According to Claim 6 of the present invention, there is provided a matrix operation device for performing weighting operation on i pieces of inputs (i: integer not less than 1) with m or more pieces of weighting coefficients (m: integer not less than 1), comprising: a k1-th power weighting multiplication circuit for weighting the inputs with k1-th power weighting coefficients which are obtained by multiplying the weighting coefficients by 2 to the k1-th power and then integerizing the product; n−1 pieces of s bit shift multiplication circuit for performing bit shift multiplication by s bit shift (s=k2, k3, . . . , kn) on the product obtained by the k1-th power weighting multiplication circuit; n−1 pieces of t-th correction circuit for adding a t-th correction value that is calculated using t-th correction coefficients (t=1, 2, . . . , n−1, t=n−1 when s=kn), to the product obtained by the s bit shift multiplication circuit; a round-off circuit for rounding off the operation result of the (n−1)th correction circuit; and a k bit shift division circuit for performing bit shift division by k bit shift (k=k1+k2+ . . . +kn) on the operation result of the round-off circuit.

According to Claim 7 of the present invention, there is provided a matrix operation device comprising n stages of matrix operation devices which are disclosed in any of Claims 1, 4, 5, and 6, wherein the first to n-th matrix operation devices perform weighting with coefficient values in the first to n-th columns in the weighting coefficients, on input matrix values which are equally input to all the matrix operation devices; in each matrix operation device, the power of the weighting, the bit shift value of the bit shift multiplication, and the bit shift value of the bit shift division are variable values based on the coefficient values; and a matrix output value comprising the output values from the respective matrix operation devices is outputted.

According to Claim 8 of the present invention, there is provided a matrix operation device for performing weighting operation on i pieces of inputs (i: integer not less than 1) with m or more pieces of weighting coefficients (m: integer not less than 1), comprising: a k1-th power weighting multiplication circuit for weighting the inputs with k1-th power weighting coefficients which are obtained by multiplying the weighting coefficients by 2 to the k1-th power and then integerizing the product; a k2 bit shift multiplication circuit for performing bit shift multiplication by k2 bit shift on the product obtained by the k1-th power weighting multiplication circuit; a k3-th power weighting multiplication circuit for weighting the inputs with k3-th power weighting coefficients which are obtained by multiplying the weighting coefficients by 2 to the k3-th power and then intergering the product; a k4 bit shift multiplication circuit for performing bit shift multiplication by k4 bit shift on the product obtained by the k3-th power weighting multiplication circuit; a correction circuit for adding correction values that are calculated using correction coefficients, to the product obtained by the k2 bit shift multiplication circuit and to the operation result of the k4 bit shift multiplication circuit; a round-off circuit for rounding off the operation result of the correction circuit; and a bit shift division circuit for performing bit shift division by k bit shift (k=k1+k2=k3+k4) on the operation result of the round-off circuit.

According to Claim 9 of the present invention, in the matrix operation device defined in Claim 6, optimum correction coefficients are used on the basis of an allowable range of precision of the operation result of the t-th correction circuit (t=1, 2, . . . , n−1).

According to Claim 10 of the present invention, in the matrix operation device defined in Claim 8, optimum correction coefficients are used on the basis of an allowable range of precision of the operation result of the correction circuit.

According to Claim 11 of the present invention, in the matrix operation device defined in Claim 7, each of the first to n-th matrix operation devices is provided with plural bit shift multiplication circuits and plural correction circuits, and the numbers of the respective circuits are determined on the basis of the coefficient values of the weighting coefficients.

According to Claim 12 of the present invention, in the matrix operation device defined in any of Claims 1, 4, 5, 6 and 8, when differences between a smallest multiplication coefficient and the other multiplication coefficients among the multiplication coefficients of the integerized weighting coefficients are larger than a predetermined value and thereby the operation result to be subjected to correction processing becomes large, the operation result of the bit shift multiplication circuit is subjected to bit shift division without being subjected to addition of the correction value.

According to Claim 13 of the present invention, in the matrix operation device defined in any of Claims 1, 4, 5, 6, and 8, the bit shift division is performed without rounding off the correction value of the correction circuit.

According to Claim 14 of the present invention, in the matrix operation device defined in Claim 1, the operation is performed using weighting coefficients that are expressed by matrix coefficients having a large width in the matrix, and the operated data are processed by a semiconductor operation device.

According to Claim 15 of the present invention, in the matrix operation device defined in Claim 1, the weighting coefficients are weighting coefficients used for a down decoding system that is realized for thinning out high frequency components.

According to Claim 16 of the present invention, in the matrix operation device defined in Claim 1, the weighting coefficients are expressed by a matrix determinant having a large width in the matrix.

### EFFECTS OF THE INVENTION

According to the present invention, a matrix operation device for performing weighting operation on i pieces of inputs (i: an integer not less than 1) by using m or more pieces of weighting coefficients (m: integer not less than 1), comprises a k1-th power weighting multiplication circuit for weighting the inputs with k1-th power weighting coefficients which are obtained by multiplying the weighting coefficients by 2 to the k1-th power and then integerizing the product; a k2 bit shift multiplication circuit for performing bit shift multiplication by k2 bit shift on the multiplication result of the k1-th power weighting multiplication circuit; a correction circuit for adding a correction value that is calculated using correction coefficients, to the multiplication result of the k2 bit shift multiplication circuit; a round-off circuit for rounding off the operation result of the correction circuit; and a k bit shift division circuit for performing bit shift division by k bit shift (k=k1+k2) on the operation result of the round-off circuit. Since the correction value is added to the operation result, it is not necessary to perform significant expansion for the original weighting coefficients, which has conventionally been required, and easy shift operation is realized in the multiplier, thereby realizing significant reduction in the scale of the entire operation circuit as well as significant improvement in the operation accuracy relative to the conventional operation circuit scale. Further, since the operation circuit scale is reduced, improvement of timing or the like can be easily realized, whereby increase in the operation circuit scale relating to the timing problem can be prevented by reducing delay elements for a temporary storage circuit.

According to Claim 1 of the present invention, there is provided a matrix operation device for performing weighting operation on i pieces of inputs (i: an integer not less than 1) by using m or more pieces of weighting coefficients (m: integer not less than 1), comprising: a k1-th power weighting multiplication circuit for weighting the inputs with k1-th power weighting coefficients which are obtained by multiplying the weighting coefficients by 2 to the k1-th power and then integerizing the product; a k2 bit shift multiplication circuit for performing bit shift multiplication by k2 bit shift on the multiplication result of the k1-th power weighting multiplication circuit; a correction circuit for adding a correction value that is calculated using correction coefficients, to the multiplication result of the k2 bit shift multiplication circuit; a round-off circuit for rounding off the operation result of the correction circuit; and a k bit shift division circuit for performing bit shift division by k bit shift (k=k1+k2) on the operation result of the round-off circuit. Therefore, the total circuit scale can be reduced, and the operation accuracy can be increased. Further, it is possible to reduce a temporary storage circuit for improving the arithmetic processing speed, which has conventionally been required due to the large-scale multiplication circuit.

According to Claim 2 of the present invention, in the matrix operation device defined in Claim 1, the correction coefficients are coefficients for correcting differences between the results which are obtained by weighting the inputs with the k1-th power weighting coefficients and then subjecting the product to k2 bit shift multiplication, and the results which are obtained by weighting the inputs with the coefficients that are obtained by multiplying the weighting coefficients by two to the k-th power. Therefore, the correction processing can be carried out so as to increase the accuracy of the operation result.

According to Claim 3 of the present invention, in the matrix operation device defined in Claim 1, optimum correction coefficients are used on the basis of an allowable range of precision of the operation result of the correction circuit. Therefore, the correction processing can be carried out using the correction coefficients that are suited to the finally-needed operation accuracy.

According to Claim 4 of the present invention, there is provided a matrix operation device for performing weighting operation on i pieces of inputs (i: integer not less than 1) with m or more pieces of weighting coefficients (m: integer not less than 1), comprising: a k1-th power weighting multiplication circuit for weighting the inputs with k1-th power weighting coefficients which are obtained by multiplying the weighting coefficients by 2 to the k1-th power and then integerizing the product; a first correction circuit for adding a first correction value that is calculated using first correction coefficients, to the product obtained by the k1-th power weighting multiplication circuit; a k2 bit shift multiplication circuit for performing bit shift multiplication by k2 bit shift on the operation result of the first correction circuit; a second correction circuit for adding a second correction value that is calculated using second correction coefficients, to the product obtained by the k2-th power weighting multiplication circuit; a round-off circuit for rounding off the operation result of the second correction circuit; and a k bit shift division circuit for performing bit shift division by k bit shift (k=k1+k2) on the operation result of the round-off circuit. Since the first correction processing is carried out by the first correction circuit before performing the bit shift multiplication and the second correction processing is carried out by the second correction circuit after the bit shift multiplication, the operation result to be subjected to the correction processing becomes small, whereby the circuit scales of the first and second correction circuits can be reduced, leading to reduction in the circuit scale of the whole device.

According to Claim 5 of the present invention, there is provided a matrix operation device for performing weighting operation on i pieces of inputs (i: integer not less than 1) with m or more pieces of weighting coefficients (m: integer not less than 1), comprising: a k1-th power weighting multiplication circuit for weighting the inputs with k1-th power weighting coefficients which are obtained by multiplying the weighting coefficients by 2 to the k1-th power and then integerizing the product; a k2 bit shift multiplication circuit for performing bit shift multiplication by k2 bit shift on the product obtained by the k1-th power weighting multiplication circuit; a first correction circuit for adding a first correction value that is calculated using first correction coefficients, to the product obtained by the k2 bit shift multiplication circuit; a k3 bit shift multiplication circuit for performing bit shift multiplication by k3 bit shift on the operation result of the first correction circuit; a second correction circuit for adding a second correction value that is calculated using second correction coefficients, to the product obtained by the k3 bit shift multiplication circuit; a round-off circuit for rounding off the operation result of the second correction circuit; and a k bit shift division circuit for performing bit shift division by k bit shift (k=k1+k2+k3) on the operation result of the round-off circuit. Therefore, even when there are differences in the coefficient values of the weighting coefficients or the coefficient values are small, since the bit shift multiplication and the correction for the multiplication result are respectively divided into two steps such that the operation result of the first bit shift multiplication circuit is subjected to the first correction processing and the operation result of the second bit shift multiplication circuit is subjected to the second correction processing, the operation result to be subjected to the correction processing becomes small, whereby the scales of the first and second correction circuits can be reduced, leasing to reduction in the circuit scale of the whole device.

According to Claim 6 of the present invention, there is provided a matrix operation device for performing weighting operation on i pieces of inputs (i: integer not less than 1) with m or more pieces of weighting coefficients (m: integer not less than 1), comprising: a k1-th power weighting multiplication circuit for weighting the inputs with k1-th power weighting coefficients which are obtained by multiplying the weighting coefficients by 2 to the k1-th power and then integerizing the product; n−1 pieces of s bit shift multiplication circuit for performing bit shift multiplication by s bit shift (s=k2, k3, . . . , kn) on the product obtained by the k1-th power weighting multiplication circuit; n−1 pieces of t-th correction circuit for adding a t-th correction value that is calculated using t-th correction coefficients (t=1, 2, . . . , n−1, t=n−1 when s=kn), to the product obtained by the s bit shift multiplication circuit; a round-off circuit for rounding off the operation result of the (n−1)th correction circuit; and a k bit shift division circuit for performing bit shift division by k bit shift (k=k1+k2+ . . . +kn) on the operation result of the round-off circuit. Therefore, it is possible to reduce the operation bit width in the case where the maximum operation result in the weighting multiplication is considered, whereby the scales of the bit shift multiplication circuit and the correction circuit can be reduced.

According to Claim 7 of the present invention, there is provided a matrix operation device comprising n stages of matrix operation devices which are disclosed in any of Claims 1, 4, 5, and 6, wherein the first to n-th matrix operation devices perform weighting with coefficient values in the first to n-th columns in the weighting coefficients, on input matrix values which are equally input to all the matrix operation devices; in each matrix operation device, the power of the weighting, the bit shift value of the bit shift multiplication, and the bit shift value of the bit shift division are variable values based on the coefficient values; and a matrix output value comprising the output values from the respective matrix operation devices is outputted. Therefore, the circuit scales of the multiplication circuit and the like in a specific matrix operation device among the plural matrix operation devices can be increased while reducing the circuit scales of the multiplication circuits and the like in the other matrix operation devices, according to the coefficient values of the weighting coefficients, whereby the total circuit scale can be reduced.

According to Claim 8 of the present invention, there is provided a matrix operation device for performing weighting operation on i pieces of inputs (i: integer not less than 1) with m or more pieces of weighting coefficients (m: integer not less than 1), comprising: a k1-th power weighting multiplication circuit for weighting the inputs with k1-th power weighting coefficients which are obtained by multiplying the weighting coefficients by 2 to the k1-th power and then integerizing the product; a k2 bit shift multiplication circuit for performing bit shift multiplication by k2 bit shift on the product obtained by the k1-th power weighting multiplication circuit; a k3-th power weighting multiplication circuit for weighting the inputs with k3-th power weighting coefficients which are obtained by multiplying the weighting coefficients by 2 to the k3-th power and then intergering the product; a k4 bit shift multiplication circuit for performing bit shift multiplication by k4 bit shift on the product obtained by the k3-th power weighting multiplication circuit; a correction circuit for adding correction values that are calculated using correction coefficients, to the product obtained by the k2 bit shift multiplication circuit and to the operation result of the k4 bit shift multiplication circuit; a round-off circuit for rounding off the operation result of the correction circuit; and a bit shift division circuit for performing bit shift division by k bit shift (k=k1+k2=k3+k4) on the operation result of the round-off circuit. Therefore, for example, when the values of the weighting coefficients are large, the total circuit scale can be reduced by reducing the number of weighting multiplications while increasing the number of bit shifts.

According to Claim 9 of the present invention, in the matrix operation device defined in Claim 6, optimum correction coefficients are used on the basis of an allowable range of precision of the operation result of the t-th correction circuit (t=1, 2, . . . , n−1). Therefore, the correction processing can be carried out using the correction coefficients that are suited to the finally-needed operation accuracy.

According to Claim 10 of the present invention, in the matrix operation device defined in Claim 8, optimum correction coefficients are is used on the basis of an allowable range of precision of the operation result of the correction circuit. Therefore, the correction processing can be carried out using the correction coefficients that are suited to the finally-needed operation accuracy.

According to Claim 11 of the present invention, in the matrix operation device defined in Claim 7, each of the first to n-th matrix operation devices is provided with plural bit shift multiplication circuits and plural correction circuits, and the numbers of the respective circuits are determined on the basis of the coefficient values of the weighting coefficients. Therefore, multiplication of the correction coefficients and bit shift operation can be carried out by using appropriate numbers of bit shift multiplication circuits and correction circuits so that differences between the ideal values of the operation results for the weighting coefficients and the operation results obtained by using the correction coefficients and bit shift multiplication become coefficients which are integers or values close to the integers and are realized by only bit shift.

According to Claim 12 of the present invention, in the matrix operation device defined in any of Claims 1, 4, 5, 6 and 8, when differences between a smallest multiplication coefficient and the other multiplication coefficients among the multiplication coefficients of the integerized weighting coefficients are larger than a predetermined value and thereby the operation result to be subjected to correction processing becomes large, the operation result of the bit shift multiplication circuit is subjected to bit shift division without being subjected to addition of the correction value. Therefore, the total operation amount can be reduced relative to the case where addition of the correction value is performed.

According to Claim 13 of the present invention, in the matrix operation device defined in any of Claims 1, 4, 5, 6, and 8, the bit shift division is performed without rounding off the correction value of the correction circuit. Therefore, the total operation amount can be reduced relative to the case where round-off processing is performed to keep the symmetric property of the weighting coefficients.

According to Claim 14 of the present invention, in the matrix operation device defined in Claim 1, the operation is performed using weighting coefficients that are expressed by matrix coefficients having a large width in the matrix, and the operated data are processed by a semiconductor operation device. Since the operation result of the matrix operation device is not larger than that obtained by the conventional matrix operation device, the capacity of the temporary storage memory of the semiconductor operation device for holding the operation result can be reduced.

According to Claim 15 of the present invention, in the matrix operation device defined in Claim 1, the weighting coefficients are weighting coefficients used for a down decoding system that is realized for thinning out high frequency components. Therefore, even when a specific multiplied value becomes extremely large in the weighting multiplication because there is a large difference in the coefficients in the matrix operation by a system for such as down-sampling or up-sampling, the circuit scales of the multiplication circuit and the like can be reduced relative to the conventional matrix operation device, whereby the total circuit scale can be reduced.

According to Claim 16 of the present invention, in the matrix operation device defined in Claim 1, the weighting coefficients are expressed by a matrix determinant having a large width in the matrix. Therefore, even when a specific multiplied value becomes extremely large in the weighting multiplication because there is a large difference in the coefficients in the matrix operation using the weighting coefficients in the weighting multiplication circuit, the circuit scales of the multiplication circuit and the like can be reduced relative to the conventional matrix operation device, whereby the total circuit scale can be reduced.

### BRIEF DESCRIPTION OF THE DRAWINGS

FIG. 1 is a block diagram illustrating the construction of the conventional matrix operation device.

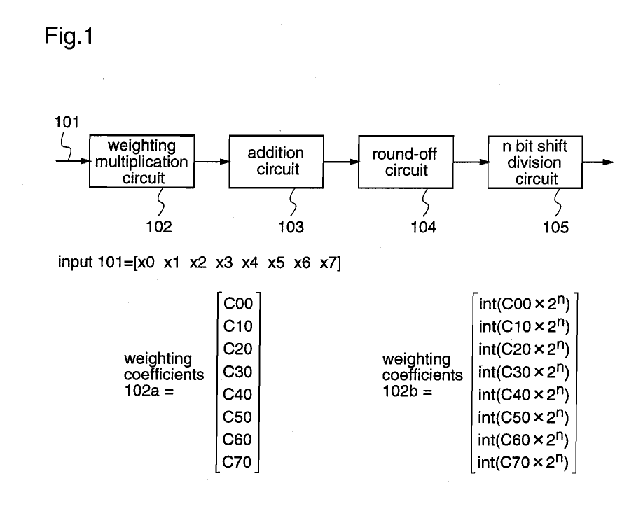

FIG. 2 is a diagram illustrating the specific construction of the conventional matrix operation device.

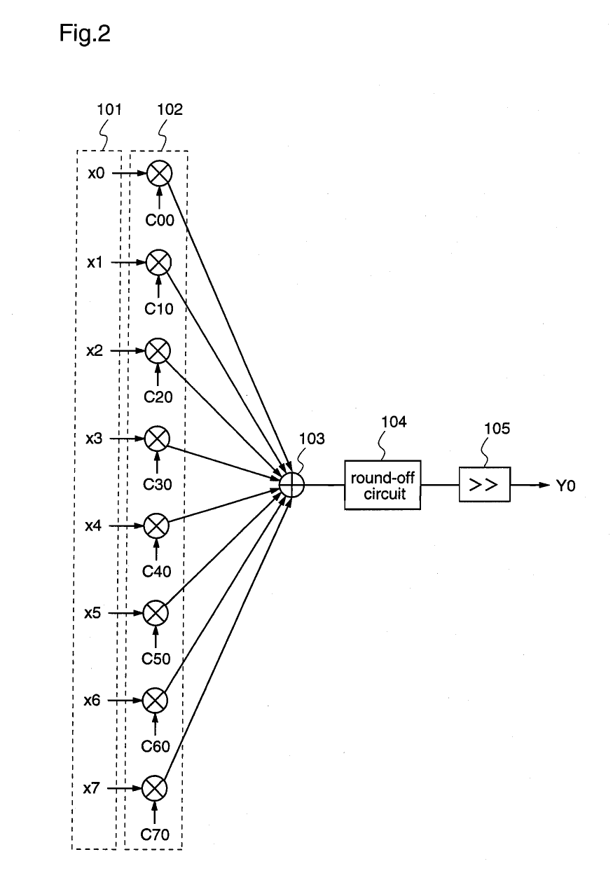

FIG. 3 is a block diagram illustrating an example of a matrix operation device according to a first embodiment of the present invention.

FIG. 4 is a diagram illustrating the specific construction of the example of the matrix operation device according to the first embodiment of the present invention.

FIG. 5 is a block diagram illustrating the construction of another example of the matrix operation device according to the first embodiment of the present invention.

FIG. 6 is a diagram illustrating the specific construction of the other example of the matrix operation device according to the first embodiment of the present invention.

FIG. 7 is a block diagram illustrating still another example of the matrix operation device according to the first embodiment of the present invention.

FIG. 8 is a diagram illustrating the specific construction of the still other example of the matrix operation device according to the first embodiment of the present invention.

FIG. 9 is a block diagram illustrating the construction of a further example of the matrix operation device according to the first embodiment of the present invention.

FIG. 10 is a diagram illustrating the specific construction of the further example of the matrix operation device according to the first embodiment of the present invention.

FIG. 11 is a diagram illustrating the specific construction of the further example of the matrix operation device according to the first embodiment of the present invention.

FIG. 12 is a block diagram illustrating an example of a matrix operation device according to a second embodiment of the present invention.

FIG. 13 is a diagram illustrating the specific construction of the example of the matrix operation device according to the second embodiment of the present invention.

FIG. 14 is a block diagram illustrating an example of a semiconductor operation device having the matrix operation device according to the first embodiment of the present invention.

### DESCRIPTION OF THE REFERENCE NUMERALS

101 . . . input
102 . . . weighting multiplication circuit
102a . . . weighting coefficients of weighting multiplication circuit 102
102b . . . weighting coefficients obtained by multiplying weighting coefficients 102a by 2ⁿ and then interring the products, when being implemented by hardware
103 . . . addition circuit
104 . . . round-off circuit
105 . . . n bit shift division circuit
202 . . . k201-th power weighting multiplication circuit
202a . . . weighting coefficients weighted on input 101
202b . . . weighting coefficients obtained by multiplying 202a by
2^{k201} and integering the products
203 . . . addition circuit
204 . . . round-off circuit
205 . . . n bit shift division circuit
206 . . . k202 bit shift multiplication circuit
207 . . . correction circuit
210 . . . first correction circuit
220 . . . second correction circuit
230 . . . k203 bit shift multiplication circuit
240 . . . kn bit shift multiplication circuit
250 . . . (n−1)th correction circuit
302b . . . weighting coefficients obtained by multiplying an upper side (C00˜C30) of 102a by 2^{K303} and integering the products, and multiplying a lower side (C40˜C70)of 102a by 2^{K304} and integering the products
303 . . . k303-th power weighting multiplication circuit
304 . . . k304-th power weighting multiplication circuit
305 . . . first addition circuit
305a . . . operation result of first addition circuit 305
306 . . . second addition circuit
306a . . . operation result of second addition circuit 306
307 . . . k307 bit shift multiplication circuit
(k303+k307=k304+k308)
307a . . . operation result of k307 bit shift multiplication circuit 307
308 . . . k308 bit shift multiplication circuit (k303+k307=k304+k308)
308a . . . operation result of k308 bit shift multiplication circuit 308
309 . . . correction circuit for adding correction value to operation result of k307 bit shift multiplication circuit and operation result of k308 bit shift multiplication circuit
309a . . . operation result of correction circuit 309
310 . . . n bit shift division circuit (n=k303+k307=k304+k308)
310a . . . operation result of n bit shift division circuit 310
311 . . . round-off circuit
401 . . . variable-length decoder
402 . . . inverse quantizer
403 . . . inverse DCT unit
404 . . . motion compensation unit
405 . . . matrix operation circuit
406 . . . temporary storage memory
407 . . . adder
600 . . . matrix operation device

### BEST MODE TO EXECUTE THE INVENTION

### Embodiment 1

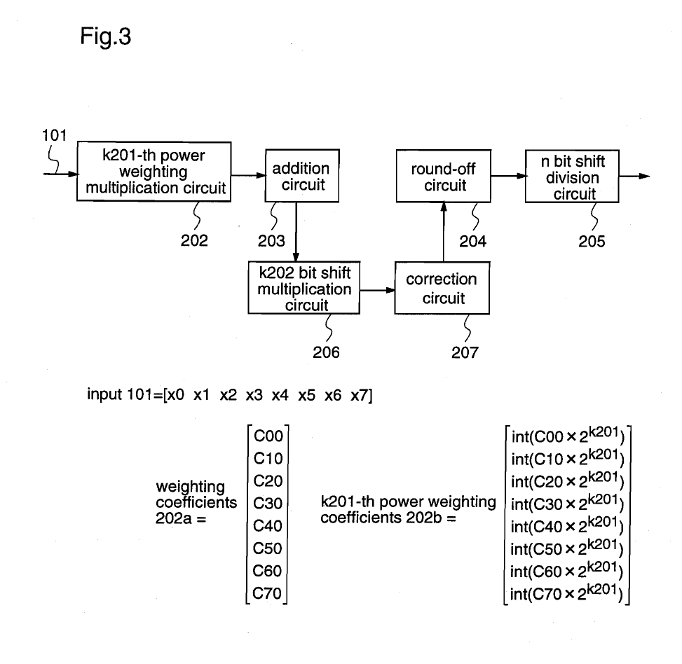

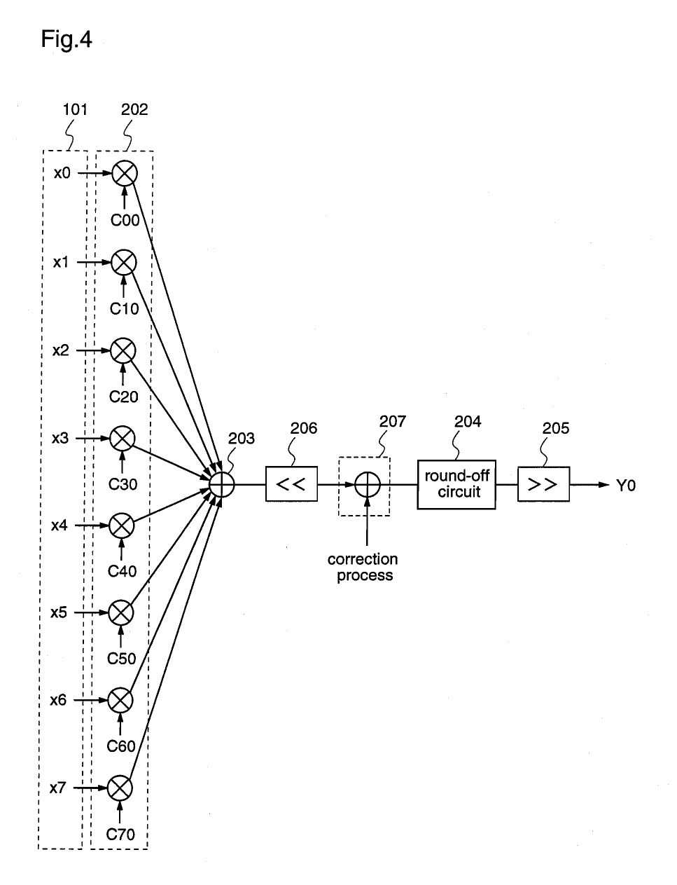

FIG. 3 is a block diagram illustrating a matrix operation device according to a first embodiment of the present invention, and FIG. 4 is a configuration diagram of the matrix operation device according to the first embodiment of the present invention.

With reference to FIGS. 3 and 4, 101 denotes an input, 202 denotes a k201-th power weighting multiplication circuit, 203 denotes an addition circuit, 204 denotes a round-off circuit, 205 denotes an n-bit shift division circuit, 206 denotes a k202 bit shift multiplication circuit, and 207 denotes a correction circuit. Further, 202b denotes k201-th power weighting coefficients which are obtained by multiplying weighting coefficients 202a by 2 to the k201-th power and then integerizing the products by round-off.

In FIGS. 3 and 4, it is assumed that the input 101 comprises eight inputs, and the weighting coefficients 202a and the k201-th power weighting coefficients 202b are matrixes each comprising 8 rows×1 column. In FIG. 3, when it is assumed that k201=6, k202=4, n=k201+k202=10, the input 101=[180 219 121 63 198 105 195 109], and the weighting coefficients 102a=[0.366 0.316 0.476 0.687 0.41 0.524 0.639 0.29], the k201-th power weighting coefficients 202b are calculated as [int(23.42) int(20.25) int(30.48) int(44) int(26.25) int(33.52) int(40.91) int(18.57)]=[23 20 30 44 26 34 41 19] (int(x) is a function which is integerized by rounding off the x to the whole number), whereby the operation result of the addition circuit becomes 180×23+219×20+121×30+63×44+198×26+105×34+195×41+109×19=33706. This operation result is multiplied by 16 in 4-bit shift multiplication, resulting in 539296.

Now, correction values to be used in the correction circuit 207 will be examined as follows. Ideal values can be calculated as weighting coefficients=[374.69 323.97 487.66 703.93 420.03 536.37 654.62 297.1] which are obtained by multiplying the weighting coefficients 202a by 2 to the 10th power, and weighting coefficients=[368 320 480 704 416 544 656 304] can be realized by subjecting the k201-th power weighting coefficients 202b=[23 20 30 44 26 34 41 19] to 4 bit shift multiplication by the k202 bit shift multiplication circuit 206, whereby difference coefficients=[6.69 3.97 7.66 −0.07 4.03 −7.63 −1.38 −6.9] can be obtained. Although these difference coefficients are used as correction coefficients, in order to realize higher precision relative to the conventional operation method, it is necessary to add correction difference coefficients which are smaller than difference coefficients=[−0.31 −0.03 −0.34 −0.07 0.03 0.37 −0.38 0.1] obtained between the weighting coefficients=[374.69 323.97 487.66 703.93 420.03 536.37 654.62 297.1] that are obtained by multiplying the weighting coefficients 202a by 2 to the 10th power, and the integerized coefficients=[375 324 488 704 420 536 655 297].

Therefore, in the correction circuit 207, correction is performed by adding the correction coefficients that can be realized by only bit shift operation, using correction coefficients=[4+2+½ 4 8−¼ 0 4 −8 −1 −8+1]=[6.5 4 7.75 0 4 −8 −1 −7] for the difference coefficients=[6.69 3.97 7.66−0.07 4.03 −7.63 −1.38 −6.9]. Thereby, the correction values in the correction processing circuit 207 are respectively calculated by [{(180<<2)+(180<<1)+(180>>1)} (219<<2) {(121<<3)−(121>>2)} 0 (198<<2)−(105<<3)−195 {−(109<<3)+109}]. Here, y<<n means that the numeral y is shifted to left by n bits, and y>>n means that the numeral y is shifted to right by n bits. The correction values are calculated as [720+360+90 876 968−30 0 792−840−195−872+109]=[1170 876 938 0 792−840−195−763], and the correction values are added to the above-mentioned result of the 4 bit shift multiplication, i.e., 539296+1170+876+938+792−840−195−763=541274. The multiplication result obtained in the conventional matrix operation device is 180×375+219×324+121×488+63×704+198×420+105×536+195×655+109×297=541394, and the expected value of the multiplication result obtained without performing integerization is 180×374.69+219×323.97+121×487.66+63×703.93+198×420.03+105×536.37+195×654.62+109×297.1=541267.67. When this expected value is compared with the multiplication result obtained by the conventional matrix operation device and with the multiplication result obtained by the matrix operation device of the present invention, it is found that the present invention can ensure an operation accuracy that is equal to or higher than the operation accuracy obtained by the conventional device. Further, since the matrix operation device is provided with the k201-th power weighting multiplication circuit 202 and the k202 bit shift multiplication circuit 206, the multiplication coefficients for the first multiplication can be reduced to reduce the scale of the multiplication circuit, and the operation bit widths of the respective circuits in the matrix operation device can be reduced when the maximum operation result is considered, thereby realizing significant reduction in the circuit scale.

As for the correction coefficients in the correction circuit, optimum correction coefficients should be selected on the basis of the allowable range of precision of the operation result obtained in the correction circuit.

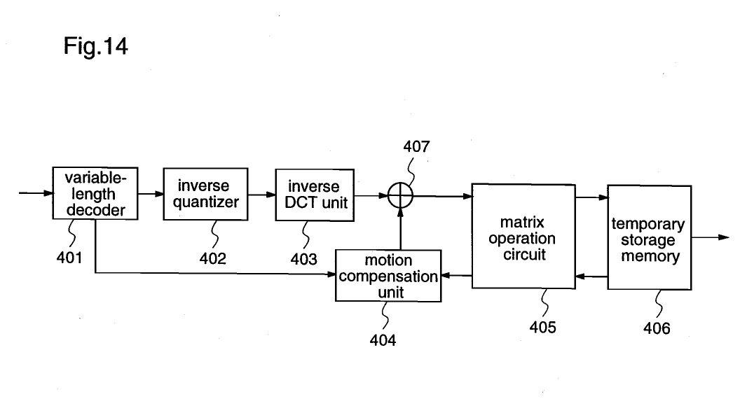

FIG. 14 is a block diagram illustrating an example of a semiconductor arithmetic apparatus having the matrix operation device according to the first embodiment of the present invention.

In FIG. 14, 401 denotes a variable-length decoder, 402 denotes an inverse quantizer, 403 denotes an inverse DCT unit, 404 denotes a motion compensation unit, 405 denotes a matrix operation circuit, 406 denotes a temporary storage memory, and 407 denotes an adder.

Initially, externally-supplied coded moving picture data is input to the variable-length decoder 401, decoded by the variable-length decoder 401, inversely quantized by the inverse quantizer 402, and inverse DCT transformed by the inverse DCT unit 403, thereby generating difference picture data.

The adder 407 adds the difference picture data and picture data read from the temporary storage memory 406 to generate reproduced moving picture data. When a picture to be decoded is a motion compensation block, the motion compensation unit 404 reads a block required for motion compensation from the temporary storage memory 406 to perform picture restoration. The restored picture is subjected to matrix operation by the matrix operation circuit 405 to be converted into data, and the converted data is stored in the temporary storage memory 406. Further, the data stored in the temporary storage memory 406 is input to the matrix operation circuit 405, and converted into data in the matrix operation circuit 405. The converted data is input to the motion compensation unit 404, and subjected to motion compensation.

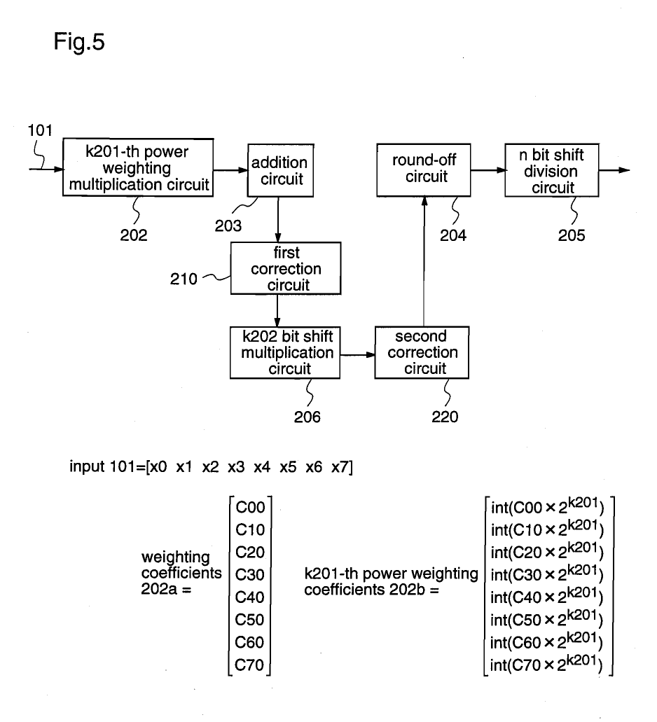

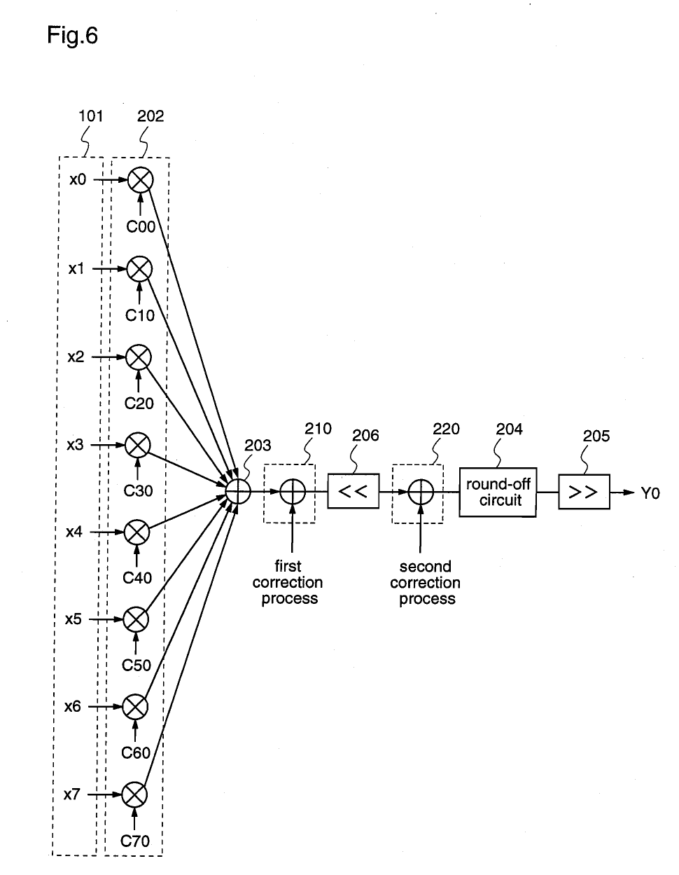

As shown in FIGS. 5 and 6, a first correction circuit 210 may be disposed between the addition circuit 203 and the k202 bit shift multiplication circuit 206 in the matrix operation device shown in FIG. 3, and a second correction circuit 220 may be disposed behind the k202 bit shift multiplication circuit 206. In the correction circuit, when differences between the ideal values and the weighting coefficients obtained by the bit shift operation are large, the weighting coefficients may be once corrected by the first correction circuit 210 before performing the bit shift operation by the k202 bit shift multiplication circuit 206, and the obtained values may be subjected to bit shift multiplication and then again corrected by the second correction circuit 220, whereby the differences between the ideal values and the weighting coefficients obtained by the bit shift operation are reduced, whereby the scale of the correction circuit can be reduced.

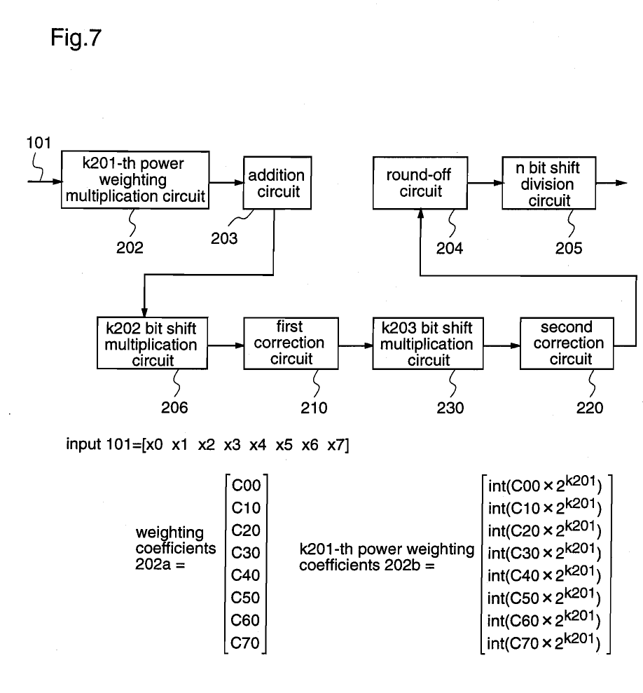

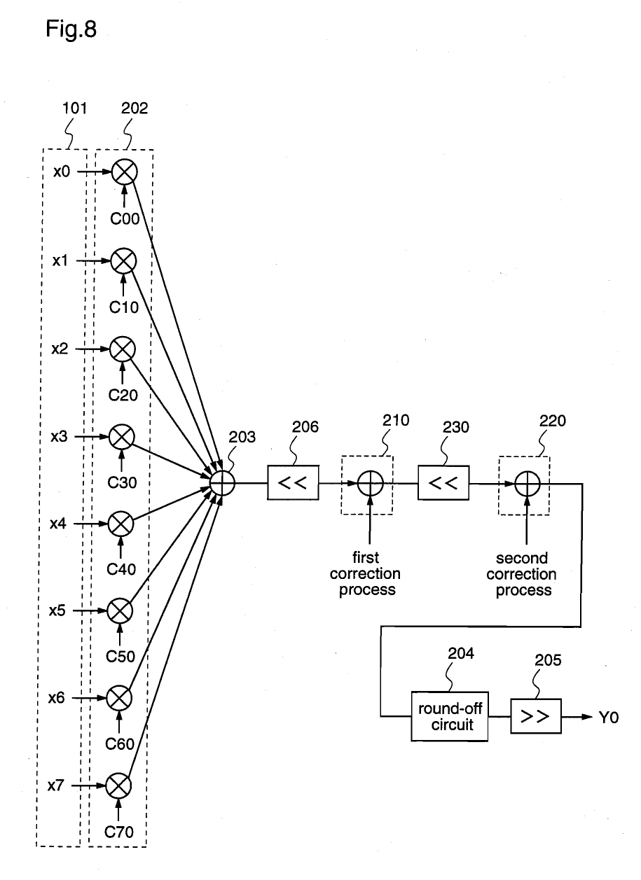

Further, as shown in FIGS. 7 and 8, a k202 bit shift multiplication circuit 206, a first correction circuit 210, a k203 bit shift multiplication circuit 230, and a second correction circuit 220 may be provided between the addition circuit 203 and the round-off circuit 204 in the matrix operation device shown in FIG. 3. When the two bit-shift multiplication circuits are provided, the operation bit width of the correction circuit in the case where the maximum operation result is considered can be reduced, whereby the scale of the correction circuit can be reduced.

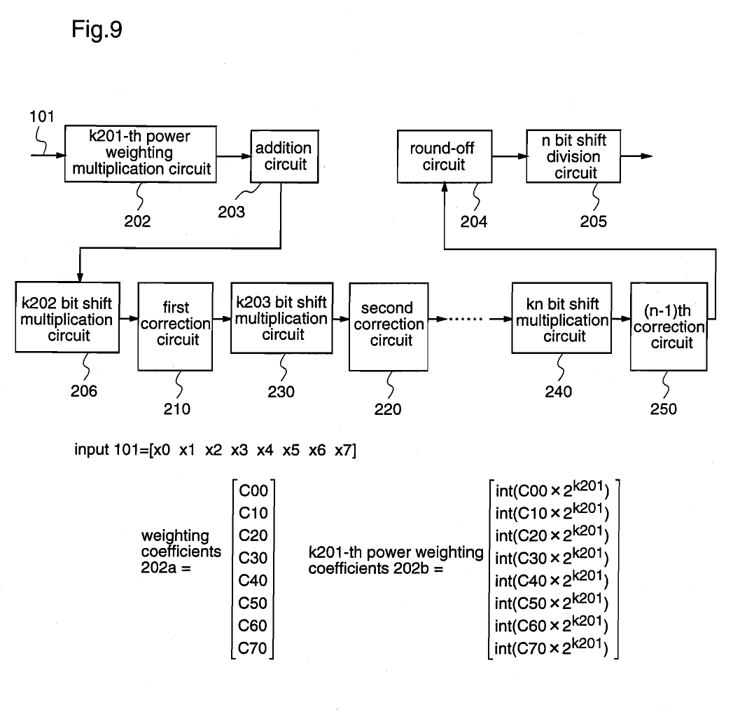

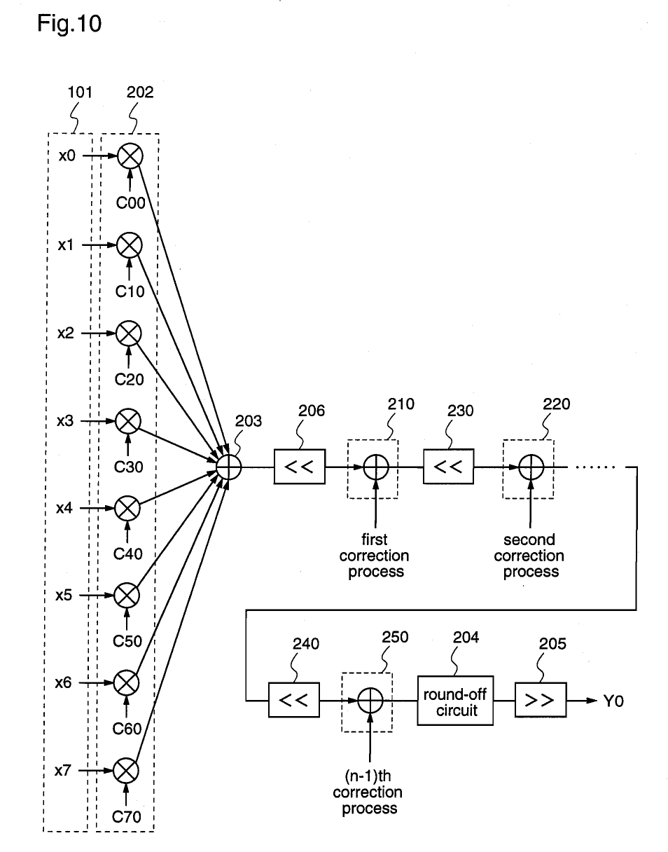

Further, two or more bit shift operation circuits and two or more correction circuits may be provided. For example, the multiplication by 2 to the k-th power which is performed on the weighting coefficients may be divided into n stages (n: integer not less than 2, n=k1+k2+ . . . +kn) of multiplications such as multiplication by 2 to the k1-th power, multiplication by 2 to the k2-th power, . . . , multiplication by 2 to the kn-th power, and (n−1) pieces of s bit shift multiplication circuits (s=k2,k3, . . . , kn) and (n−1) pieces of t-th correction circuits (t=1, 2, . . . , n−1) may be provided. For example, as shown in FIGS. 9 and 10, the k202 bit shift multiplication circuit 206, the first correction circuit 210, the k203 bit shift multiplication circuit 230, the second correction circuit 220, the kn bit shift multiplication circuit 240, and the (n−1)th correction circuit 250 may be provided between the addition circuit 203 and the round-off circuit 204. Thereby, the operation bit width of the matrix operation device in the case where the maximum operation result is considered can be reduced, resulting in reduction in scales of the bit shift multiplication circuits and the correction circuits.

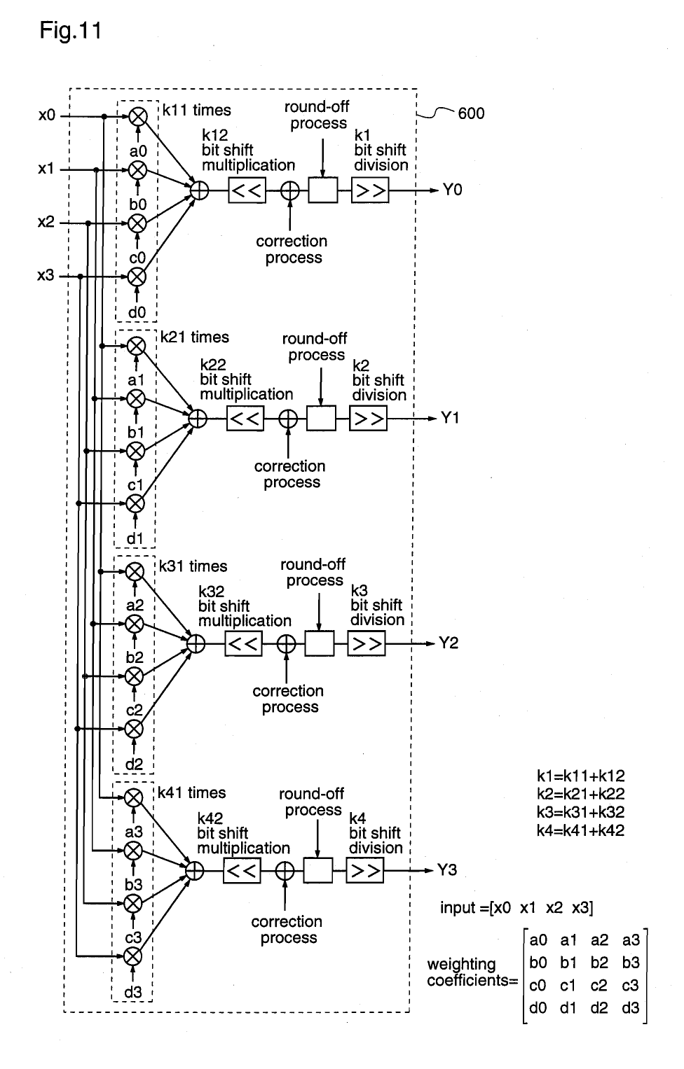

Further, in this first embodiment, the number of inputs is eight, and the weighting coefficients are in a matrix comprising 8 rows×1 column. However, when the number of inputs is four and the weighting coefficients are in a matrix comprising 4 rows×4 columns as shown in FIG. 11, the matrix operation circuit 600 is provided with four stages of matrix operation units each having a weighting multiplication circuit, an addition circuit, a bit shift multiplication circuit, a correction circuit, a round-off circuit, and a bit shift division circuit as shown in FIG. 3. In this case, the first to fourth matrix operation units perform weighting using the coefficient values in the first to fourth columns of the weighting coefficients, on the input matrix values that are inputted as the same values to the respective matrix operation units. In each matrix operation unit, the multiplier for weighting, the bit shift value of bit shift multiplication, and the bit shift value of bit shift division are variable values based on the coefficient values, and the matrix operation device outputs matrix output values comprising the output values from the respective matrix operation units. in the first-stage matrix operation unit among the four stages of matrix operation units included in the matrix operation device 600, weighting is performed on the inputs to the first-stage matrix operation unit by using weighting coefficients that are obtained by multiplying the weighting coefficient values in the first column by 2 to the k11-th power and then integering the product, and the multiplication result obtained by the weighting multiplication is subjected to bit shift multiplication by k12 bit shift. Then, a correction value calculated using the correction coefficients is added to the multiplication result obtained by the bit shift multiplication, and the operation result obtained by the addition of the correction value is subjected to round-off, and further, the operation result obtained by the round-off is subjected to bit shift division by k1 bit shift (k1=k11+k12). Also in the second, third, and fourth stages of matrix operation units, weighting is performed on the inputs to the second-stage, third-stage, and fourth-stage matrix operation units by using weighting coefficients that are obtained by multiplying the weighting coefficient values in the second, third, and fourth columns by 2 to the k21-th power, k32-th power, and k41-th power, respectively, and then integering the products, and the multiplication results obtained by the weighting multiplication are subjected to bit shift multiplication by k22, k32, and k42 bit shifts, respectively. Then, correction values calculated using the correction coefficients are added to the multiplication results obtained by the bit shift multiplication, and the operation results obtained by the addition of the correction values are subjected to round-off, and further, the operation results obtained by the round-off are subjected to bit shift division by k2, k3, and k4 bit shifts (k2=k21+k22, k3=k31+k32, k4=k41+k42), respectively. By adopting the above-mentioned construction, it is possible to increase the circuit scale of only a specific matrix operation unit among the four-stages of matrix operation units, while reducing the circuit scales of the other devices, whereby the total circuit scale can be reduced.

The number of the matrix operation units is not restricted to four, and n stages of matrix operation units may be provided. Further, the plural matrix operation units may have different numbers of bit shift multiplication circuits and correction circuits. In this case, in each matrix operation unit, the numbers of the bit shift multiplication circuits and the correction circuits are determined on the basis of the values of the weighting coefficients, whereby the matrix operation unit can perform multiplication of correction coefficients and bit shift multiplication by adjusting the numbers of the correction circuits and the bit shift multiplication circuits on the basis of the values of the weighting coefficients so that the differences between the ideal values of the operation results for the weighting coefficients and the operation results obtained by using the correction coefficients and the bit shift multiplication become integers or values close to the integers (coefficients that can be realized by only bit shift, such as bit shift by 2 times, 1 time, or ½ time).

Further, when differences between the minimum multiplication coefficient and the other multiplication coefficients among the integerized weighting coefficients are larger than a predetermined value and thereby the operation result to be subjected to correction processing is large, the operation result of the bit shift multiplication circuit may be subjected to bit shift division without being subjected to addition of the correction value.

Further, when the weighting coefficients 202a do not have a symmetrical structure, no round-off processing may be performed on the correction value of the correction circuit.

Further, it is possible to adopt weighting coefficients used by a system for down-decoding such as down-sampling or up-sampling which is realized for thinning out high-frequency components. Further, the weighting coefficients are expressed as a matrix determinant having a large width in the matrix.

As described above, according to the first embodiment, the matrix operation device for performing weighting operation on eight inputs by using the weighting coefficients 202a, comprises the k201-th power weighting multiplication circuit 202 for weighting the inputs with the k201-th power weighting coefficients 202b which are obtained by multiplying the weighting coefficients 202a by 2 to the k201-th power and then integerizing the product, the k202 bit shift multiplication circuit 206 for performing bit shift multiplication by k202 bit shift on the multiplication result of the k201-th power weighting multiplication circuit 202, the correction circuit for adding a correction value that is calculated using correction coefficients to the multiplication result of the k202 bit shift multiplication circuit 206, the round-off circuit 204 for rounding off the operation result of the correction circuit 207, and the n bit shift division circuit 205 for performing bit shift division by n bit shift (n=k201+k202) on the operation result of the round-off circuit 204. Therefore, the circuit scales of the multiplication circuits and the like can be reduced, whereby the total circuit scale can be reduced, and further, operation accuracy can be improved by performing the correction processing on the operation result.

### Embodiment 2

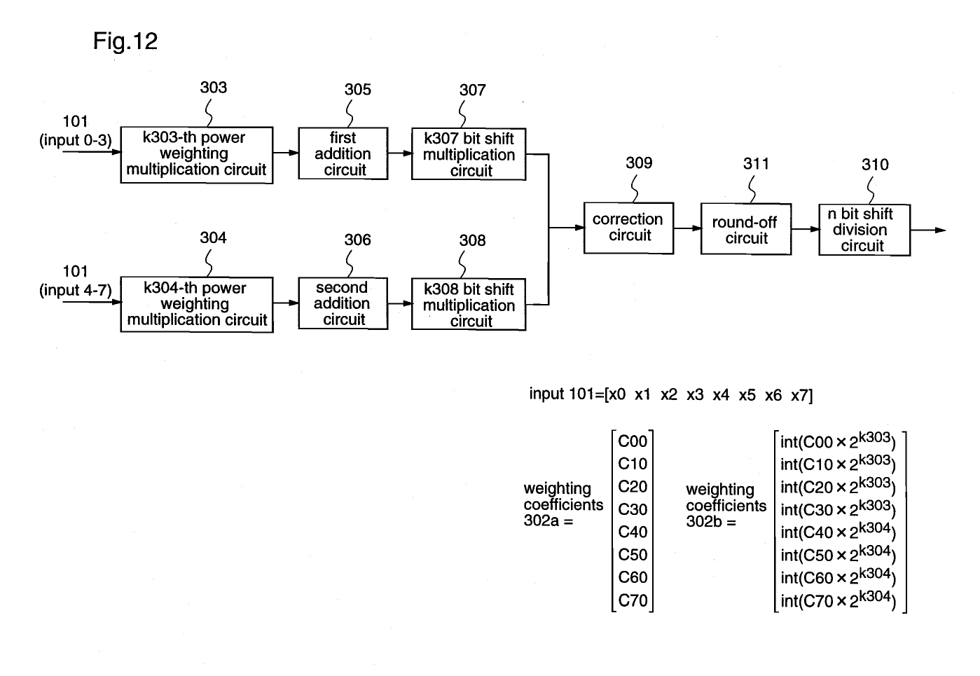

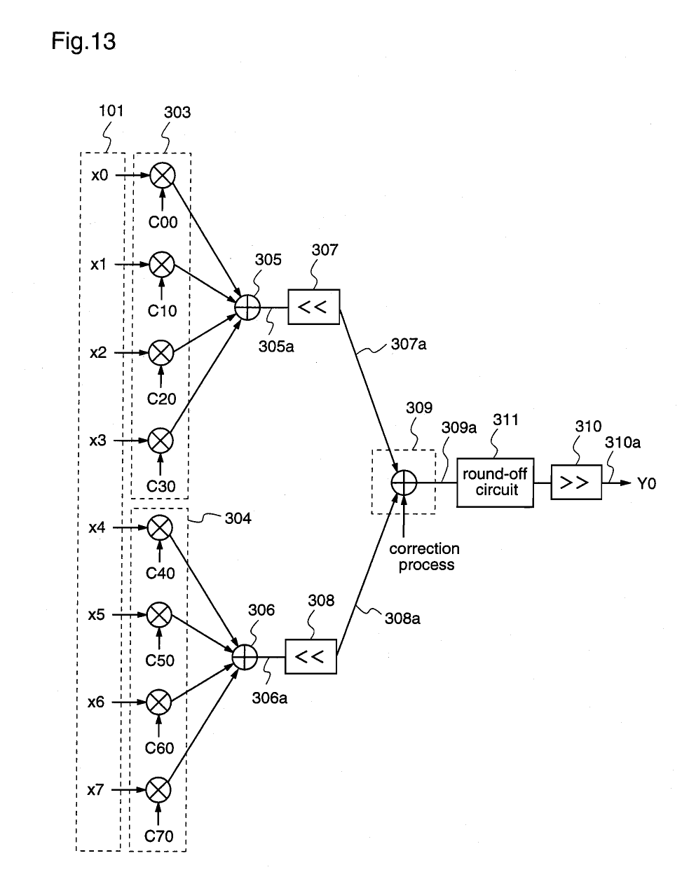

FIG. 12 is a block diagram illustrating a matrix operation device according to a second embodiment of the present invention, and FIG. 13 is a configuration diagram of the matrix operation device according to the second embodiment.

In FIGS. 12 and 13, 303 denotes a k303-th power weighting multiplication circuit, 304 denotes a k304-th power weighting multiplication circuit, 305 and 306 denote first and second addition circuits, 307 denotes a k307 bit shift multiplication circuit (k303+k307=k304+d308), 308 denotes a k308 bit shift multiplication circuit (k303+k307=k304+k308), 309 denotes a correction circuit for adding correction values to the product of the k307 bit shift multiplication circuit 307 and the product of the k308 bit shift multiplication circuit 308, 310 denotes an n bit shift division circuit (n=k303+k307=k304+k308), and 311 denotes a round-off circuit.

Further, 302b denotes weighting coefficients which are obtained by multiplying an upper side (C00˜C30) of weighting coefficients 102a by 2^{k304} and integerizing the product, and multiplying a lower side (C40˜C70) of the weighting coefficients 102a by 2k³⁰⁴ and integerizing the product, 305a denotes an operation result of the first addition circuit 305, 306a denotes an operation result of the second addition circuit 306, 307a denotes an operation result of the k307 bit shift multiplication circuit, 308a denotes an operation result of the k308 bit shift multiplication circuit, 309a denotes an operation result of the correction circuit 309, and 310a denotes an operation result of the n bit shift division circuit 310.

In this second embodiment of the present invention, the plural inputs are independent from each other halfway in the arithmetic operation, and weighting coefficients corresponding to the respective inputs are multiplied by individual coefficients to realize weighting coefficients. While in this second embodiment the weighting coefficients are a matrix comprising 8 rows×1 column, weighting multiplication may be performed by using weighting coefficients in a matrix comprising m rows X n columns.

In the case where eight weighting coefficients are provided for the eight inputs and the operations on the respective inputs can be halfway separated into the operation results for the inputs 0 to 3 and the operation results for the inputs 4 to 7, when it is assumed that the inputs 101=[180 219 121 63 198 105 195 109], and the weighting coefficients 302a=[0.366 0.316 0.476 0.687 0.41 0.524 0.639 0.29], the inputs 0 to 3 are multiplied by 2 to the k303-th power in the k303-th power weighting multiplication circuit 303 and then subjected to k307 bit shift multiplication in the k307 bit shift multiplication circuit 307, while the inputs 4 to 7 are multiplied by 2 to the k304-th power in the k304-th power weighting multiplication circuit 304 and then subjected to k308 bit shift multiplication in the k308 bit shift multiplication circuit 308.

Assuming that k303=5, k304=6, and k308=4, the coefficients by which the inputs 0 to 3 are to be multiplied in the k303-th power weighting multiplication circuit 303 are multiplied by 2 to the 5th power while the coefficients by which the inputs 4 to 7 are to be multiplied in the k304-th power weighting multiplication circuit 304 are multiplied by 2 to the 6th power, and thus obtained weighting coefficients 302b=[11.71 10.12 15.24 22 26.25 33.52 40.91 18.58] are integerized to obtain the weighting coefficients 302b=[12 10 15 22 26 34 41 19]. The products 303 obtained by multiplying the inputs 0 to 3 by the weighting coefficients 302b are added by the first addition circuit 305, resulting in an operation result 305a=180×12+219×10+121×15+63×22=7551, and the products 304 obtained by multiplying the inputs 4 to 7 by the weighting coefficients 302b are added by the second addition circuit 306, resulting in an operation result 306a=198×26+105×34+195×41+109×19=18784.

Next, the operation result 305a corresponding to the inputs 0 to 3 is multiplied by 32 by 5 bit shift multiplication while the operation result 306a corresponding to the inputs 4 to 7 is multiplied by 16 by 4 bit shift multiplication. Then, the operation result 307a of the k307 bit shift multiplication circuit 307 is calculated as 307a=7551×32=241632 while the operation result 308a of the k308 bit shift multiplication circuit 308 is calculated as k308=18784×16=300544, resulting in the bit shift multiplication=241632+300544=5422176.

Next, when calculating a correction value for performing correction, correction coefficients are determined considering a difference from the result obtained when performing real number operation, as an operation error, and the circuit scale. Ideal values can be calculated as weighting coefficients=[374.69 323.97 487.66 703.93 420.03 536.37 654.62 297.1] which are obtained by multiplying the weighting coefficients 202a by 2 to the 10th power, and weighting coefficients=[384 320 480 704 416 544 656 304] are realized by subjecting the inputs 0 to 3 to 5 bit shift operation while subjecting the inputs 4 to 8 to 4 bit shift operation with respect to the weighting coefficients 302b=[12 10 15 22 26 34 41 19], whereby the differences from the real number calculation result, which are difference coefficients, can be calculated as [−9.31 3.97 7.66 −0.07 4.03 −7.63 −1.38 −6.9]. Since the differences from the real number calculation result are [−9.31 3.97 7.66 −0.07 4.03 −7.63-1.38 −6.9], correction coefficients=[−9 4 8 0 4 −8 −1 −7] are calculated by the same calculation method as described for the first embodiment. A correction value calculated using the correction coefficients becomes 180×(−9)+219×4+121×8+63×0+198×4+105×(−8)+195×(−1)+109×(−7)=−782. This correction value is added to the operation result 307a of the k307 bit shift multiplication circuit 307 and to the operation result 308a of the k308 bit shift multiplication circuit 308, whereby the operation result 309a of the correction circuit 309 becomes 542176+(−782)=541394.

Since the multiplication result obtained by the conventional matrix operation device is 180×375+219×324+121×488+63×704+198×420+105×536+195×655+109×297=541394, the matrix operation device according to the second embodiment of the present invention can obtain the result of the same precision as that obtained in the conventional device. Further, more precise result can be obtained by improving the precision of the correction value.

As for the correction coefficients used in the correction circuit, optimum correction coefficients are selected on the basis of the allowable range of precision of the operation result of the correction circuit.

Further, when differences between the minimum multiplication coefficient and the other multiplication coefficients among the integerized weighting coefficients are larger than a predetermined value and thereby the operation result to be subjected to correction processing becomes large, the operation result of the bit shift multiplication circuit may be subjected to bit shift division without being subjected to addition of the correction value.

Further, when the weighting coefficients 302a do not have a symmetrical structure, no round-off processing may be performed on the correction value of the correction circuit. As described above, according to the second embodiment, the matrix operation device for performing weighting operation on eight inputs by using the weighting coefficients 302a, comprises the k303-th power weighting multiplication circuit 303 for weighting the inputs with the k303-th power weighting coefficients which are obtained by multiplying the weighting coefficients 302a by 2 to the k303-th power and then integerizing the product, the k307 bit shift multiplication circuit 307 for performing bit shift multiplication by k307 bit shift on the multiplication result of the k303-th power weighting multiplication circuit, the k304-th power weighting multiplication circuit 304 for weighting the inputs by the k304-th power weighting coefficients which are obtained by multiplying the weighting coefficients 302a by 2 to the k304-th power and the integering the product, the k308 bit shift multiplication circuit 308 for performing bit shift multiplication by k308 bit shift on the multiplication result of the k304-th power weighting multiplication circuit, the correction circuit 309 for adding a correction value that is calculated using the correction coefficients to the multiplication result of the k307 bit shift multiplication circuit 307 and to the multiplication result of the k308 bit shift multiplication circuit 308, the round-off circuit 311 for rounding off the operation result of the correction circuit 309, and the n bit shift division circuit 310 for performing bit shift division by n bit shift (n=k303+k307=k304+k308) on the operation result of the round-off circuit 311. Therefore, the operation bit width in the case where the maximum operation result of the weighting multiplication is considered is reduced, and the number of bit shifts is increased, thereby reducing the circuit scale.

### APPLICABILITY IN INDUSTRY

According to a matrix operation device of the present invention, since correction coefficients are added to operation results, significant expansion of coefficients for original weighting coefficients that has conventional been required is not required, thereby realizing a simple shift operation in a multiplier, and therefore, a considerable circuit reduction for the whole operation circuit as well as a considerable precision increase in the operation precision relative to the conventional operation circuit, and therefore, the matrix operation device is useful as an operation device for image conversion in video signal processing or the like.

1. A matrix operation device for performing weighting operation on i pieces of inputs (i: an integer not less than 1) by using m or more pieces of weighting coefficients (m: integer not less than 1), said device comprising:
a k1-th power weighting multiplication circuit for weighting said inputs with k1-th power weighting coefficients which are obtained by multiplying said weighting coefficients by 2 to the k1-th power and then integerizing the product;
a k2 bit shift multiplication circuit for performing bit shift multiplication by k2 bit shift on the multiplication result of the k1-th power weighting multiplication circuit;
a correction circuit for adding a correction value that is calculated using correction coefficients, to the multiplication result of the k2 bit shift multiplication circuit;
a round-off circuit for rounding off the operation result of the correction circuit; and
a k bit shift division circuit for performing bit shift division by k bit shift (k=k1+k2) on the operation result of the round-off circuit.

2. A matrix operation device as defined in claim 1 wherein said correction coefficients are coefficients for correcting differences between the results which are obtained by weighting the inputs with the k1-th power weighting coefficients and then subjecting the products to k2 bit shift multiplication, and the results which are obtained by weighting the inputs with the coefficients that are obtained by multiplying said weighting coefficients by two to the k-th power.

3. A matrix operation device as defined in claim 1 wherein optimum correction coefficients are used on the basis of an allowable range of precision of the operation result of the correction circuit.

4. A matrix operation device for performing weighting operation on i pieces of inputs (i: integer not less than 1) with m or more pieces of weighting coefficients (m: integer not less than 1), said device comprising:
a k1-th power weighting multiplication circuit for weighting said inputs with k1-th power weighting coefficients which are obtained by multiplying said weighting coefficients by 2 to the k1-th power and then integerizing the product;
a first correction circuit for adding a first correction value that is calculated using first correction coefficients, to the product obtained by the k1-th power weighting multiplication circuit;
a k2 bit shift multiplication circuit for performing bit shift multiplication by k2 bit shift on the operation result of the first correction circuit;
a second correction circuit for adding a second correction value that is calculated using second correction coefficients, to the product obtained by the k2-th power weighting multiplication circuit;
a round-off circuit for rounding off the operation result of the second correction circuit; and
a k bit shift division circuit for performing bit shift division by k bit shift (k=k1+k2) on the operation result of the round-off circuit.

5. A matrix operation device for performing weighting operation on i pieces of inputs (i: integer not less than 1) with m or more pieces of weighting coefficients (m: integer not less than 1), said device comprising:
a k1-th power weighting multiplication circuit for weighting said inputs with k1-th power weighting coefficients which are obtained by multiplying said weighting coefficients by 2 to the k1-th power and then integerizing the product;
a k2 bit shift multiplication circuit for performing bit shift multiplication by k2 bit shift on the product obtained by the k1-th power weighting multiplication circuit;
a first correction circuit for adding a first correction value that is calculated using first correction coefficients, to the product obtained by the k2 bit shift multiplication circuit;
a k3 bit shift multiplication circuit for performing bit shift multiplication by k3 bit shift on the operation result of the first correction circuit;
a second correction circuit for adding a second correction value that is calculated using second correction coefficients, to the product obtained by the k3 bit shift multiplication circuit;
a round-off circuit for rounding off the operation result of the second correction circuit; and
a k bit shift division circuit for performing bit shift division by k bit shift (k=k1+k2+k3) on the operation result of the round-off circuit.

6. A matrix operation device for performing weighting operation on i pieces of inputs (i: integer not less than 1) with m or more pieces of weighting coefficients (m: integer not less than 1), said device comprising:
a k1-th power weighting multiplication circuit for weighting said inputs with k1-th power weighting coefficients which are obtained by multiplying said weighting coefficients by 2 to the k1-th power and then integerizing the product;
n−1 pieces of s bit shift multiplication circuit for performing bit shift multiplication by s bit shift (s=k2, k3, . . . , kn) on the product obtained by the k1-th power weighting multiplication circuit;
n−1 pieces of t-th correction circuit for adding a t-th correction value that is calculated using t-th correction coefficients (t=1, 2, . . . , n−1, t=n−1 when s=kn), to the product obtained by the s bit shift multiplication circuit;
a round-off circuit for rounding off the operation result of the (n−1)th correction circuit; and
a k bit shift division circuit for performing bit shift division by k bit shift (k=k 1+k2+ . . . +kn) on the operation result of the round-off circuit.

7. A matrix operation device comprising n stages of matrix operation devices which are disclosed in claim 1, wherein
the first to n-th matrix operation devices perform weighting with coefficient values in the first to n-th columns in the weighting coefficients, on input matrix values which are equally input to all the matrix operation devices;
in each matrix operation device, the power of the weighting, the bit shift value of the bit shift multiplication, and the bit shift value of the bit shift division are variable values based on said coefficient values; and
a matrix output value comprising the output values from the respective matrix operation devices is outputted.

8. A matrix operation device for performing weighting operation on i pieces of inputs (i: integer not less than 1) with m or more pieces of weighting coefficients (m: integer not less than 1), said device comprising:
a k1-th power weighting multiplication circuit for weighting said inputs with k1-th power weighting coefficients which are obtained by multiplying said weighting coefficients by 2 to the k1-th power and then integerizing the product;
a k2 bit shift multiplication circuit for performing bit shift multiplication by k2 bit shift on the product obtained in the k1-th power weighting multiplication circuit;
a k3-th power weighting multiplication circuit for weighting said inputs with k3-th power weighting coefficients which are obtained by multiplying said weighting coefficients by 2 to the k3-th power and then intergering the product;
a k4 bit shift multiplication circuit for performing bit shift multiplication by k4 bit shift on the product obtained by the k3-th power weighting multiplication circuit;
a correction circuit for adding correction values that are calculated using correction coefficients, to the product obtained by the k2 bit shift multiplication circuit and to the product obtained by the k4 bit shift multiplication circuit;
a round-off circuit for rounding off the operation result of the correction circuit; and
a bit shift division circuit for performing bit shift division by k bit shift (k=k1+k2=k3+k4) on the operation result of the round-off circuit.

9. A matrix operation device as defined in claim 6 wherein optimum correction coefficients are used on the basis of an allowable range of precision of the operation result of the t-th correction circuit (t=1, 2, . . . , n−1).

10. A matrix operation device as defined in claim 8 wherein optimum correction coefficients are used on the basis of an allowable range of precision of the operation result of the correction circuit.

11. A matrix operation device as defined in claim 7 wherein each of the first to n-th matrix operation devices is provided with plural bit shift multiplication circuits and plural correction circuits, the numbers of the respective circuits being determined on the basis of the coefficient values of the weighting coefficients.

12. A matrix operation device as defined in claim 1, wherein, when differences between a smallest multiplication coefficient and the other multiplication coefficients among the multiplication coefficients of the integerized weighting coefficients are larger than a predetermined value and thereby the operation result to be subjected to correction processing becomes large, the operation result of the bit shift multiplication circuit is subjected to bit shift division without being subjected to addition of the correction value.

13. A matrix operation device as defined in claim 1, wherein the bit shift division is performed without rounding off the correction value of the correction circuit.

14. A matrix operation device as defined in claim 1 wherein the operation is performed using weighting coefficients that are expressed by matrix coefficients having a large width in the matrix, and the operated data are processed by a semiconductor operation device.

15. A matrix operation device as defined in claim 1 wherein said weighting coefficients are weighting coefficients which are used for a down-decoding system that is realized for thinning out high frequency components.

16. A matrix operation device as defined in claim 1 wherein said weighting coefficients are expressed by a matrix determinant having a large width in the matrix.

17. A matrix operation device comprising n stages of matrix operation devices which are disclosed in claim 4, wherein
the first to n-th matrix operation devices perform weighting with coefficient values in the first to n-th columns in the weighting coefficients, on input matrix values which are equally input to all the matrix operation devices;
in each matrix operation device, the power of the weighting, the bit shift value of the bit shift multiplication, and the bit shift value of the bit shift division are variable values based on said coefficient values; and
a matrix output value comprising the output values from the respective matrix operation devices is outputted.

18. A matrix operation device comprising n stages of matrix operation devices which are disclosed in claim 5, wherein
the first to n-th matrix operation devices perform weighting with coefficient values in the first to n-th columns in the weighting coefficients, on input matrix values which are equally input to all the matrix operation devices;
in each matrix operation device, the power of the weighting, the bit shift value of the bit shift multiplication, and the bit shift value of the bit shift division are variable values based on said coefficient values; and
a matrix output value comprising the output values from the respective matrix operation devices is outputted.

19. A matrix operation device comprising n stages of matrix operation devices which are disclosed in claim 6, wherein
the first to n-th matrix operation devices perform weighting with coefficient values in the first to n-th columns in the weighting coefficients, on input matrix values which are equally input to all the matrix operation devices;
in each matrix operation device, the power of the weighting, the bit shift value of the bit shift multiplication, and the bit shift value of the bit shift division are variable values based on said coefficient values; and
a matrix output value comprising the output values from the respective matrix operation devices is outputted.

20. A matrix operation device as defined in claim 4, wherein, when differences between a smallest multiplication coefficient and the other multiplication coefficients among the multiplication coefficients of the integerized weighting coefficients are larger than a predetermined value and thereby the operation result to be subjected to correction processing becomes large, the operation result of the bit shift multiplication circuit is subjected to bit shift division without being subjected to addition of the correction value.

21. A matrix operation device as defined in claim 5, wherein, when differences between a smallest multiplication coefficient and the other multiplication coefficients among the multiplication coefficients of the integerized weighting coefficients are larger than a predetermined value and thereby the operation result to be subjected to correction processing becomes large, the operation result of the bit shift multiplication circuit is subjected to bit shift division without being subjected to addition of the correction value.

22. A matrix operation device as defined in claim 6, wherein, when differences between a smallest multiplication coefficient and the other multiplication coefficients among the multiplication coefficients of the integerized weighting coefficients are larger than a predetermined value and thereby the operation result to be subjected to correction processing becomes large, the operation result of the bit shift multiplication circuit is subjected to bit shift division without being subjected to addition of the correction value.

23. A matrix operation device as defined in claim 8, wherein, when differences between a smallest multiplication coefficient and the other multiplication coefficients among the multiplication coefficients of the integerized weighting coefficients are larger than a predetermined value and thereby the operation result to be subjected to correction processing becomes large, the operation result of the bit shift multiplication circuit is subjected to bit shift division without being subjected to addition of the correction value.

24. A matrix operation device as defined in claim 4, wherein the bit shift division is performed without rounding off the correction value of the correction circuit.

25. A matrix operation device as defined in claim 5, wherein the bit shift division is performed without rounding off the correction value of the correction circuit.

26. A matrix operation device as defined in claim 6, wherein the bit shift division is performed without rounding off the correction value of the correction circuit.

27. A matrix operation device as defined in claim 8, wherein the bit shift division is performed without rounding off the correction value of the correction circuit.
